(19) United States
(12) Patent Application Publication
(10) Pub. No.: US 2005/0087973 A1
(43) Pub. Date: Apr. 28, 2005

(54) School bus safety scheme

(76) Inventor: Leon Cornell, Pomfret Center, CT (US)

Correspondence Address: FISHER, CHRISTEN & SABOL, 1725 K STREET, N.W., SUITE 1108, WASHINGTON, DC, 20006, US

(21) Appl. No.: 10/968,973

(22) Filed: Oct. 21, 2004

Related U.S. Application Data
(60) Provisional application No. 60/512,781, filed on Oct. 21, 2003.
(60) Provisional application No. 60/514,597, filed on Oct. 28, 2003.

(51) Int. Cl. B60R 22/00

(52) U.S. Cl. 280/801.1

(57) ABSTRACT

The improvement school bus safety scheme comprising at least one seat belt for each passenger on the bus, each of the seat belts having two belt portions, one end of each of the two belt portions being affixed to the floor, the two belt portions being adapted to be detachably joined together so as to fit around the waist of a passenger, the distance between the front of the bottom portion of each seat and the back of the back portion of the seat in front thereof being such that, when the torso of the passenger in the seat bends forward to a substantially horizontal position, there is no contact of head of the passenger with back portion of seat in front of the passenger. Also may include electronic means that include a control means either in the front of the bus or even outside of the bus by which the two belt portions that are adapted to be detachably joined together can be automatically released either in the front of the bus or even outside of the bus with the control means, perhaps by the bus driver.

This application has priority benefit of both U.S. Provisional Application No. 60/512,781, filed on Oct. 21, 2004 and U.S. Provisional Application No. 60/514,597, filed on Oct. 28, 2004.

### BACKGROUND OF THE INVENTION

1. Field of the Invention

The invention relates to a safety scheme for vehicles. In particular, the invention relates to a safety scheme including seat belts for the passengers in a school bus. The invention also relates to electronic means that include a control means either in the front of the bus or even outside of the bus by which the two seat belt portions that are adapted to be detachably joined together can be automatically released either in the front of the bus or even outside of the bus with the control means, perhaps by the bus driver. The invention further relates to the use of seat belts in school buses.

2. Background Art

The problem of injuries of passengers being injured on school buses is very serious. Often when a school bus is in an accident or has to swerve or stop suddenly, if a passenger is injured, the injury involves a head injury in particular. Many school districts stagger the use of their one or more school buses so as to use a single school bus to take students ranging from the primary and kindergarten level through high school to and from school at different times during the day. School buses often are used for transportation that includes adult monitors and the like.

### BROAD DESCRIPTION OF THE INVENTION

The subject invention includes a school bus safety scheme that includes a safety seat belt system.

An object of the invention is to overcome the disadvantages and problems of prior art school bus safety schemes. For example, that the bus driver or another person can automatically release the seat belts of any and all of the passengers either in the front of the bus or even outside of the bus overcomes the disadvantage of only having seat belts which must be manually released. This could be particularly useful, for example, in the instance of a bus roll-over or other accident or instance. The school bus safety scheme concept is designed to maximize the safety of school children during a school bus accident.

Other objects and advantages of the invention are set out herein or are obvious herefrom to one skilled in the art.

The invention system comprises, in part, a lap belt with additional body restraint. Each passenger seat has a single lap belt for each passenger. Each passenger can open and close his or her seat belt.

The invention involves, in a school bus that includes a floor, and at least one seat being capable of seating at least one passenger, the at least one seat having a bottom portion and a back portion, an improvement school bus safety scheme comprising at least one seat belt for each of the passengers. The at least one seat belt has two belt portions. One end of each of the two belt portions is affixed to the floor. The two belt portions are adapted to be detachably joined together so as to fit around the waist of the passenger.

The invention further preferably involves, in a school bus that includes a floor, a front and a back, and at least two rows of at least one seat, each of the seats being capable of seating at least one passenger, each of the seats having a bottom portion and a back portion, an improvement school bus safety scheme comprising at least one seat belt for each of the passengers. Each of the seat belts has two belt portions. One end of each of the two belt portions is affixed to the floor. The two belt portions are adapted to be detachably joined together so as to fit around the waist of the passenger. The distance of “μ” between the front of the bottom portion of each seat and the back of the back portion of the seat in front thereof is such that, when the torso of the passenger in the seat bends forward to a substantially horizontal position, there is not any contact between the head of the passenger with the back portion of the seat in front of the passenger.

The invention also preferably involves, in a school bus that includes a front and a back, and a floor having a left side and a right side, at least two rows of at least one seat positioned along the left side of the floor, and at least two rows of at least one seat positioned along the right side of the floor, each of the seats being capable of seating at least one passenger, each seat having a bottom portion and a back portion, an improvement school bus safety scheme comprising a seat belt for each of the passengers. Each seat belt has two belt portions. One end of each of the two belt portions is affixed to the floor. The two belt portions are adapted to be detachably joined together so as to fit around the waist of the passenger. The distance “μ” between the front of the bottom portion of each seat and the back of the back portion of the seat in front thereof is such that, when the torso of the passenger in the seat bends forward to a substantially horizontal position, there is not any contact between the head of the passenger with the back portion of seat in front of the passenger.

Further, the system preferably includes that there is adequate space between the passenger seats so that a child or adult passenger will not hit his or her head on the back of the seat in front of his/her seat in case of an accident or other instance in which the bus must stop quickly. To accomplish this, preferably the seats are permanently affixed, spaced far enough apart to achieve the result of the passenger's head not hitting the back of the seat in front of the passenger in case of an accident, sudden stop or the like of the school bus. In this embodiment, the seats are permanently affixed to the floor by welding, bolting or the like. The passenger seats can also be adjustable with regard to the space between the seats. For example, the seats may be secured on floor rails with means by which each seat may be moved along the floor rails by one or more passengers to achieve the desired distance between the front of that seat and the back of the seat in front of that seat.

In general, the distance fore and aft between all of the passenger seats must be increased in the range of eighteen inches or so. That is, the distance “μ” between the front of each of the passenger seats and the back of the passenger seat in front of it preferably would be about 24 to about 26 inches. More preferably, this distance “μ” would be 24 or 25 or 26 inches.

Since the school bus may carry high school passengers and/or adults that are taller than the usual/normal passengers, some of the rows of seats may be spaced further apart than the preferred “μ” distance to accommodate them.

The school bus safety scheme also includes electronic means that include a control means either in the front of the school bus or even outside of the bus by which the two seat belt portions that are adapted to be detachably joined together can be automatically released either in the front of the bus or even outside of the bus with the control means, perhaps by the bus driver. Release may be accomplished at each location and/or by mass release under the control of the driver or another person. Thus, in the event of incapacity of the driver and or a roll-over, release can be accomplished outside of the vehicle. Of course, each passenger would also be able to manually release his or her seat belt.

For example, that the bus driver or another person can automatically release the seat belts of any and all of the passengers either in the front of the school bus or even outside of the bus overcomes the disadvantage of only having seat belts which must be manually released. This could be particularly useful, for example, in the instance of a school bus roll-over or other accident, for instance. The school bus safety scheme concept is designed to maximize the safety of school children, for example, during a school bus accident, sudden stops or swerving by the school bus, sudden stalling of the school bus, and the like.

The invention school bus safety system can also involve the use of a lap belt with additional body restraint.

U.S. Pat. No. 6,213,508, patentee Leon H. Cornell, commonly owned, discloses a device for use in conjunction with a standard three-point seat belt harness assembly to provide for restraint of potential rearward motion of a vehicle occupant. The device includes a secondary belt which is fixedly attached to one portion of the harness assembly on one side of the seat and affixedly to the floor attachment post on the opposite side of the harness assembly at the other side of the seat. An adjustable unit is provided on the second belt to tighten across the back of the occupant and for when the seat or the back of the seat is moved or adjusted. This forms part of an embodiment of the subject invention herein. The relevant disclosure in U.S. Pat. No. 6,213,508 is incorporated herein by reference. Since a school bus has seats that seat two persons, the aisle portion device would have to have the over-the-shoulder belt of the standard three-point seat belt attached to the inside of the roof of the school bus.

The combination of the additional restraint and the lap belt can be the known three-point harnesses, or shoulder belts, that are conventionally attached to vertically-spaced first and second mounting points on the vehicle's framework such as a reinforced post and the like (attachment to the ceiling of the school bus may be necessary). The opposed terminal belt ends are attached to these mounting points and a fastener is provided upon the intermediate run of belt such that the belt may be drawn across one's shoulder and chest and affixed on the other side of the seat to a third vehicle mounting point. In addition, there can be a mechanism to allow the belt to be gradually played out and frictionally withdrawn to provide a comfortable yet snug belt fit upon the user in a seated position upon the vehicle seat while additionally providing for fixed restraint during an emergency such as a vehicle accident.

U.S. patent application Ser. No. 10/372,126, filed Feb. 25, 2003, applicant Karl E. Volk, commonly owned, (status: Notice of Allowance has been issued) discloses a seat belt which comprises a continuous belt originating from a retractor located in the outer wall of the vehicle through a slip ring that is mounted to the outer wall at a height at or above the shoulder of the occupant, and continuing down the outside edge of the seat through a metal slip ring that is attached to a belt that is part of another retractor that is fastened to the floor next to the rear of the seat. The belt continues across the front of the seat back and is attached to a belt-female buckle assembly that is bolted to the floor. The male part of the buckle is a sliding type that is on the continuous belt between the two slip rings. When a person sits in the seat, the belt is already behind the person's waist, and then the belt is drawn and fastened, the belt coming across the person's chest and waist in a normal fashion. The retractors provide automatic adjustment for people of different sizes. This forms part of an embodiment of the subject invention herein. The relevant disclosure in U.S. Ser. No. 10/372,125 is incorporated herein by reference. The aisle seats in the school bus may require the over-the-shoulder belt to be attached to the inside surface of the roof of the school bus.

The school bus safety scheme of the invention achieves the objects and advantages of the invention.

Modifications and changes made to the school bus safety scheme can be effected without departing from the scope or spirit of the present invention. For example, the distance between the front of each of the passenger seats and the back of the passenger seat in front of it may be greater than 26 inches. Also, the embodiments of this school bus safety scheme, which are illustrated as follows, have been shown only by way of example and should not be taken to limit the scope of the following claims.

### BRIEF DESCRIPTION OF THE DRAWINGS

In the drawings:

FIG. 1 is a perspective view of a passenger school bus;

FIG. 2 is a front view of a passenger school bus seat with two lap seat belts of the subject invention;

FIG. 3 is a side view of two passenger seats, one directly behind the other, with a passenger sitting in the seat in back of the other, wearing a lap belt; and

FIG. 4 is a side view of two passenger seats, one directly behind the other with the distance between the front of the seat in back and the back of the seat in front indicated as distance “μ”.

### LIST OF PARTS NUMBERS

In connection with the figures, the following list of the names of the parts of the instant invention is noted:
50 passenger seat;
51 back portion of passenger seat;
52 bottom portion of passenger seat;
53 means by which the front legs of passenger seat are secured to the floor of the bus;
54 means by which the back legs of passenger seat are secured to the floor of the bus;
55 fastening (buckling) device of seat belt;
56 outer belt portion;
57 front leg of passenger seat;
58 back leg of passenger seat; and
59 inner belt portion;
60 school bus;
61 female portion of detachable seat belt bucking device; and
62 male portion of detachable seat belt buckling device.

### DETAILED DESCRIPTION OF THE INVENTION

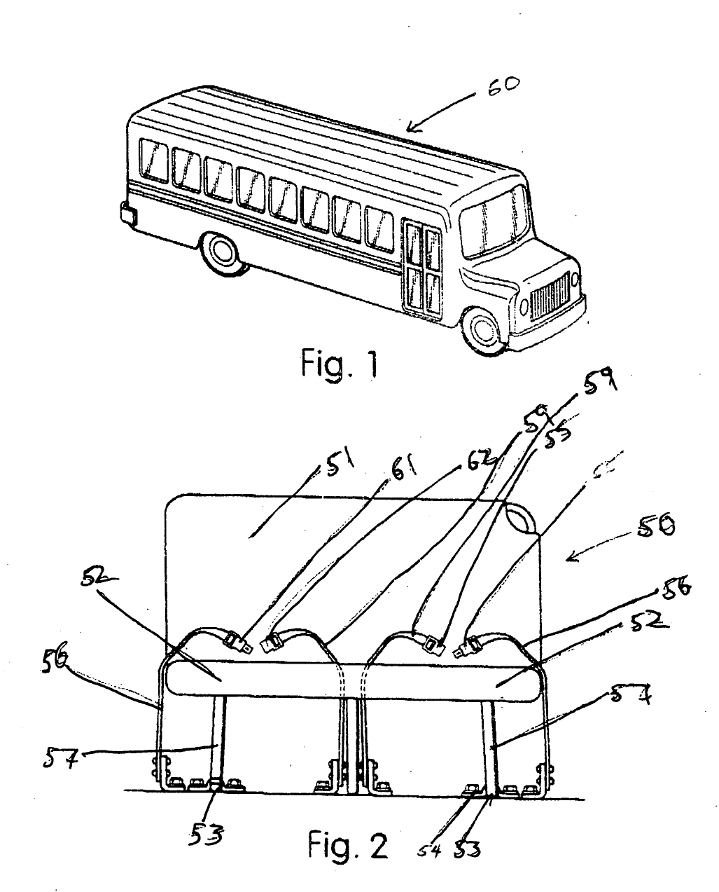

As shown in FIG. 1, the invention involves a school bus safety scheme that includes seat belts for passengers sitting in one or more passenger seats (50) in a school bus. Each passenger seat (50) has a back portion (51) and a bottom portion (52). Each passenger seat (50) has at least two front legs (57) and two back legs (58).

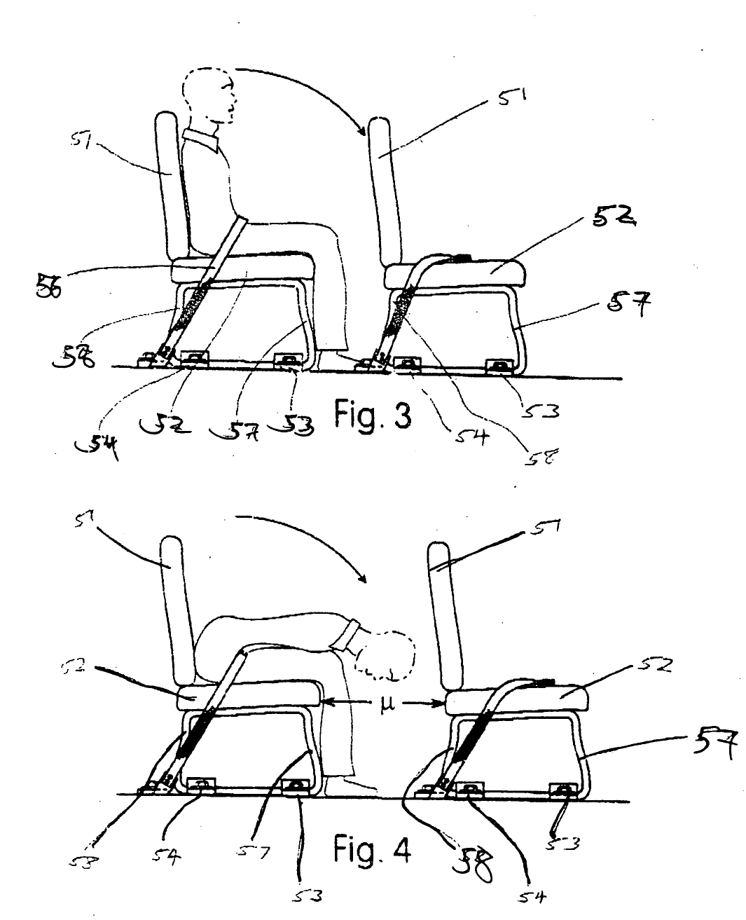

The passenger seats (50) are adjustable with regard to the space between the seats. That is, distance “μ” in FIG. 3 is adjustable. Distance “μ” may be adjusted to a distance at which a child or adult passenger will not hit his or her head on the back of the seat (51) in front of his/her seat if the bus must stop quickly and his or her torso bends forward to a substantially horizontal position in reaction. The distance “μ” between each of the passenger seats (50) must be increased by eighteen inches. That is, the distance between the front of the bottom portion (52) of each of the passenger seats and the back portion (51) of the passenger seat in front of it preferably would be about 24 to about 26 inches. More preferably, this distance “μ” would be 24 or 25 or 26 inches. The front legs (57) of the passenger seats are attached to means (53) by which the legs are secured to the floor of the bus in an adjustable, moveable manner. Likewise, the back legs (58) of the passenger seats are attached to means (54) by which the legs are secured to the floor of the bus in an adjustable, moveable manner. For example, the passenger seats (50) may be secured on floor rails with means by which each seat may be moved along the floor rails by one or more passengers to achieve the desired distance between the front of that seat and the back of the seat in front of that seat.

Each passenger seat (50) has at least one lap belt (55, 56 and 59) with additional body restraint. Each passenger seat has a single lap belt (55, 56 and 59) for each passenger. Each passenger can open and close his or her own seat belt with a fastening device (55). Part of the fastening device (55) is secured on the inner belt portion (59). Part of the fastening device (55) is secured on the outer belt portion (56). The fastening device (55) serves to fasten the two belt portions (56 and 59) of the seat belt together when the seat belt is said to be “on”. The end of the inner belt portion (59) which is opposite of the end of the inner belt portion that is secured to the fastening device (55) is secured to the floor of the bus. Also, the end of the outer belt portion (56) which is opposite of the end of the inner belt portion that is secured to the fastening device (55) is secured to the floor of the bus.

The school bus safety scheme also includes electronic means that include a control means either in the front of the bus or even outside of the bus by which the fastening device (55) securing together the inner belt portion (59) and the outer belt portion (56) of each and every passenger seat belt on the bus can be automatically released, either in the front of the bus or even outside of the bus with the control means by a person. Release may be accomplished at each location and/or by mass release under the control of the driver or another person.

1. In a school bus that includes a front and a back, and a floor having a left side and a right side, at least two rows of at least one seat positioned along the left side of the floor, and at least two rows of at least one seat positioned along the right side of the floor, each of the seats being capable of seating at least one passenger, each seat having a bottom portion and a back portion, the improvement school bus safety scheme comprising a seat belt for each of the passengers, each seat belt having two belt portions, one end of each of the two belt portions is affixed to the floor, the two belt portions being adapted to be detachably joined together so as to fit around the waist of the passenger, the distance between the front of the bottom portion of each seat and the back of the back portion of the seat in front thereof is such that, when the torso of the passenger in the seat bends forward to a substantially horizontal position, there is no contact of head of the passenger with back portion of seat in front of the passenger.

2. In a school bus that includes a floor, and at least one seat being capable of seating at least one passenger, the at least one seat having a bottom portion and a back portion, the improvement school bus safety scheme comprising at least one seat belt for each of the passengers, the at least one seat belt having two belt portions, one end of each of the two belt portions is affixed to the floor, the two belt portions being adapted to be detachably joined together so as to fit around the waist of the passenger.

3. In a school bus that includes a floor, a front and a back, and at least two rows of at least one seat, each of the seats being capable of seating at least one passenger, each of the seats having a bottom portion and a back portion, the improvement school bus safety scheme comprising at least one seat belt for each of the passengers, each of the seat belts having two belt portions, one end of each of the two belt portions being affixed to the floor, the two belt portions being adapted to be detachably joined together so as to fit around the waist of the passenger, the distance between the front of the bottom portion of each seat and the back of the back portion of the seat in front thereof being such that, when the torso of the passenger in the seat bends forward to a substantially horizontal position, there is no contact of head of the passenger with back portion of seat in front of the passenger.

4. The improvement school bus safety scheme as set forth in claim 1, further comprising at least one of the two belt portions being retractable so that when the two belt portions are detachably joined together, the belt fits snugly around the waist of the passenger.

5. The improvement school bus safety scheme as set forth in claim 2, further comprising at least one of the two belt portions being retractable so that when the two belt portions are detachably joined together, the belt fits snugly around the waist of the passenger.

6. The improvement school bus safety scheme as set forth in claim 3, further comprising at least one of the two belt portions being retractable so that when the two belt portions are detachably joined together, the belt fits snugly around the waist of the passenger.

7. The improvement school bus safety scheme as set forth in claim 1, further comprising at least one of the two belt portions being manually adjustable by the passenger so that when the two belt portions are detachably joined together the belt fits snugly around the waist of the passenger.

8. The improvement school bus safety scheme as set forth in claim 2, further comprising at least one of the two belt portions being manually adjustable by the passenger so that when the two belt portions are detachably joined together the belt fits snugly around the waist of the passenger.

9. The improvement school bus safety scheme as set forth in claim 3, further comprising at least one of the two belt portions being manually adjustable by the passenger so that when the two belt portions are detachably joined together the belt fits snugly around the waist of the passenger.

10. The improvement school bus safety scheme as set forth in claim 1, wherein the distance between the front of the bottom portion of each seat and the back of the back portion of the seat in front thereof is about 24 to about 26 inches.

11. The improvement school bus safety scheme as set forth in claim 3, wherein the distance between the front of the bottom portion of each seat and the back of the back portion of the seat in front thereof is about 24 to about 26 inches.

12. The improvement school bus safety scheme as set forth in claim 1, wherein the distance between the front of the bottom portion of each seat and the back of the back portion of the seat in front thereof is manually adjustable by the passenger.

13. The improvement school bus safety scheme as set forth in claim 3, wherein the distance between the front of the bottom portion of each seat and the back of the back portion of the seat in front thereof is manually adjustable by the passenger.

14. The improvement school bus safety scheme as set forth in claim 12, wherein each of the seats is adjustably positioned on a floor rail so that the passenger can manually adjust the distance between the front of the bottom portion of each seat and the back of the back portion of the seat in front thereof.

15. The improvement school bus safety scheme as set forth in claim 13, wherein each of the seats is adjustably positioned on a floor rail so that the passenger can manually adjust the distance between the front of the bottom portion of each seat and the back of the back portion of the seat in front thereof.

16. The improvement school bus safety scheme as set forth in claim 12, wherein the two belt portions that are adapted to be detachably joined together can be manually released by the passenger.

17. The improvement school bus safety scheme as set forth in claim 13, wherein the two belt portions that are adapted to be detachably joined together can be manually released by the passenger.

18. The improvement school bus safety scheme as set forth in claim 12, further comprising electronic means have a control means in the front of the bus by which the two belt portions that are adapted to be detachably joined together can be automatically released in the front of the bus with the control means, perhaps by the bus driver.

19. The improvement school bus safety scheme as set forth in claim 13, further comprising electronic means have a control means in the front of the bus by which the two belt portions that are adapted to be detachably joined together can be automatically released in the front of the bus with the control means, perhaps by the bus driver.

20. The improvement school bus safety scheme as set forth in claim 12, further comprising electronic means having a control mechanism not in the bus by which the two belt portions that are adapted to be detachably joined together can be automatically released outside of the bus with the control mechanism.

21. The improvement school bus safety scheme as set forth in claim 12, further comprising electronic means having a control mechanism not in the bus by which the two belt portions that are adapted to be detachably joined together can be automatically released outside of the bus with the control mechanism.
